(19) United States
(12) Patent Application Publication
(10) Pub. No.: US 2007/0170006 A1
(43) Pub. Date: Jul. 26, 2007

(54) Screw drive mechanism for an elevator

(75) Inventor: Chang-Hsin Kuo, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/285,576

(22) Filed: Nov. 22, 2005

(51) Int. Cl. B66B 9/02

(52) U.S. Cl. 187/267

(57) ABSTRACT

Reduce the power for driving the elevator by using a screw mechanism, specially the ball screw mechanism. And, for the safe reason, a revolving restriction mechanism is used to restrict the rotation of screw shaft, when screw shaft crack. Besides, a spring is used to reduce the uncomfortable feeling for the elevator failure. And, a sensor is used to check the crack for screw shaft immediately.

### BACKGROUND OF THE INVENTION

1. Field of the Invention

The present invention relates to a drive mechanism for an elevator, and more particularly to a screw drive mechanism for an elevator, which has an unrotatablly screw shaft, and a nut rotatablly and vertical screwed on a screw shaft.

2. Description of the Prior Art

An elevator is very common equipment in a metropolis; the more often seen driving type is a cable elevator, which used a cable to drive an elevator car to move up and down. However, the cable elevator is suitable for carrying a lot of passengers and goods in a large building, not useful in an apartment block. It is on grounds that tractors have to bear more torque, and thus more power is required. A normally residential power supply system can not load enough. For reducing the required horsepower of driving system for an elevator, some screw drive elevators had been researched and developed, but several problems still have existed.

Existing screw drive systems for an elevator are generally divided into the following three types:

A first type of screw drive system is such that the power unit is located above the screw shaft and serves to rotate the screw shaft, and the nut rotatablly screwed on the screw shaft is fixed on the elevator car. When the power unit drives the screw shaft rotating, the nut can be driven to move the elevator car up and down. As far as this type of screw drive system is concerned, the torque area of the screw shaft (the portion of the screw shaft subjected to the torque) ranges from the upper end of the screw shaft (the connecting portion of the screw shaft where the power unit is located) to the nut. Therefore, if the screw shaft is broken, the screw shaft must be broken within the torque area thereof. In this case, the lower half portion of the screw shaft can rotate freely relative to the upper half portion of the screw shaft when the upper half portion is rotated by the power unit, and the lower half portion of the screw shaft will rotate uncontrollably under the condition that the nut has no self-lock function (lower friction drag), resulting in a rapid fall of the elevator car.

A second type of screw drive system is such that the power unit is located below the screw shaft and serves to rotate the screw shaft, and the nut rotatablly screwed on the screw shaft is fixed on the elevator car. When the power unit drives the screw shaft rotating, the nut and the elevator car can be driven to move up and down. For this type of screw drive system, the torque area of the screw shaft ranges from the lower end of the screw shaft (the connecting portion of the screw shaft with the power unit) to the nut, and the screw shaft is susceptible to buckle when it is subjected to pressure stress. The buckling strength of the screw shaft is in proportion to the quadruplicate of diameter of the screw shaft; however, the diameter of the screw shaft cannot be as thick as that of the oil hydraulic cylinder. Therefore, the buckling strength of the screw shaft is not high, and such drive system is not ideal.

The third type of screw drive system is of nut driving system, wherein the power unit is installed on the elevator car, and the upper end of the screw shaft is unrotatablly fixed (the upper end is installed in a suspension manner for easy installation). The power unit drives the nut to move vertical along the screw shaft. The torque area of the screw shaft of this nut driving system ranges from the position the screw shaft is fixed to the nut. Therefore, if the screw shaft is broken, the screw shaft must be broken within the torque area thereof. When the screw shaft is broken, the nut will fall along with the lower half portion of the screw shaft. Even if the lower end of the screw shaft is equipped with support structure (the screw is relatively unmovable but relatively rotatable), the lower half portion of the screw shaft will rotate uncontrollably relative to the nut, and thus the fall of the elevator car might result. When the lower portion of the screw shaft is unrotatablly fixed, the screw shaft and the track of the elevator must be aligned very precisely, otherwise, there will be a great interference force between the screw shaft and the elevator track. And the problem is that the screw shaft will be deformed. On the other hand, it is difficult to construct in the elevator passage, and the screw shaft is very long, so that a precise alignment is very difficult to be achieved.

The present invention has arisen to mitigate and/or obviate the afore-described disadvantages.

### SUMMARY OF THE INVENTION

The primary objective of the present invention is to provide a safe screw drive mechanism for an elevator, wherein the elevator car will not fall even if the screw shaft of the elevator drive system is broken.

The secondary objective of the present invention is to provide a reliable screw drive mechanism for an elevator, wherein the degree of the breach of the screw shaft can be detected when the screw shaft of the elevator drive system is broken.

Another objective of the present invention is to provide an easily installable screw drive mechanism for an elevator.

A further objective of the present invention is to provide a screw drive mechanism for an elevator for relieving uncomfortableness when the elevator failure.

To achieve the objects of the present invention, the screw shaft of the elevator screw drive mechanism is preferably a ball screw shaft. Since the ball nut of the ball screw shaft utilizes balls as motion transmitting medium, its friction drag is relatively low. Therefore, the screw drive mechanism of the present invention is suitable for the lower horsepower residential elevator.

In addition, for easy installation of the screw shaft, the screw shaft is designed such that one end is a fixed end fixed to the supporting stand of the elevator, and another end is an unfixed end, it is to said a free end or a supported end. The fixed end of the screw shaft prevents rotary motion or vertical movement of the screw shaft with respect to the building. On the screw shaft is screwed a ball nut, and then the power unit is installed on the elevator car for rotating the ball nut, so that the elevator car is able to move vertically along the ball screw shaft along with the ball nut.

For improving the safety of the screw shaft, a revolving restriction mechanism is arranged at the unfixed end of the screw shaft, so that the unfixed end of the screw shaft can be kept from rotation when the screw shaft cracks, thus preventing the elevator car from crashing along with the nut.

For easily checking the abnormal signal and knowing the abnormal condition of the screw shaft, a sensor is mounted on the revolving restriction mechanism. The sensor can detect when the screw shaft cracks and the free or supported end move axially. Furthermore, a spring is disposed in the revolving restriction mechanism for reducing the uncomfortable feeling for the elevator failure.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view of showing a screw drive mechanism for an elevator in accordance with the present invention;

FIG. 2 is an enlarged view of the revolving restriction mechanism of FIG. 1;

FIG. 3 is a cross sectional view taken along line A-A′ of FIG. 2;

FIG. 4 shows a screw drive mechanism for an elevator in accordance with another embodiment of the present invention;

FIG. 5 is a cross sectional view of showing a third embodiment of the present invention; and

FIG. 6 is a cross sectional view of showing a fourth embodiment of the present invention.

### DETAILED DESCRIPTION OF THE PREFERRED EMBODIMENTS

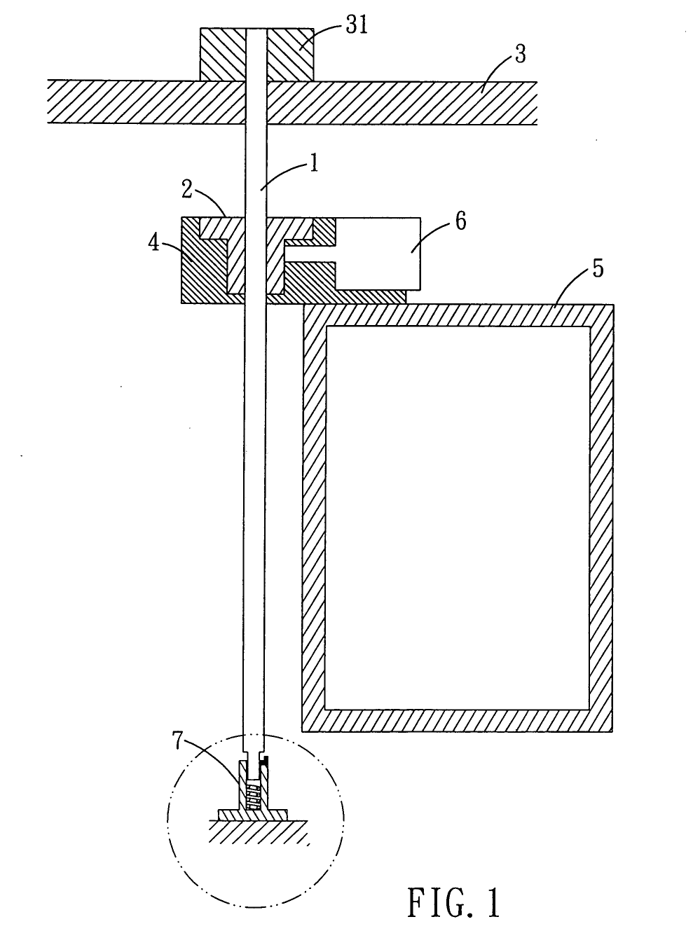

Referring to FIG. 1, a screw drive mechanism for an elevator in accordance with the present invention comprises a screw shaft 1 and a nut 2 rotatablly screwed on the screw shaft 1. To reduce the friction drag between the screw shaft 1 and the nut 2, the nut 2 can be a ball nut. The upper end ( fixed end ) of the screw shaft 1 is unrotatablly fixed to the supporting stand 3 by a locking mechanism 31, and another end is a free end, one kind of unfixed ends. The screw shaft 1 prevents rotary motion or vertical movement with respect to the supporting stand 3. An elevator-car connecting member 4 serves to connect the nut 2 and the elevator car 5, and the nut 2 is rotatable but not moveable relative to the elevator-car connecting member 4. The elevator car 5 is fixed to the elevator-car connecting member 4, when the nut 2 moves along the screw shaft 1, the elevator car 5 will move along with the nut 2. For guiding the movement of the elevator car 5 and balancing the torque applied on the elevator car 5, an elevator-car track (not shown) is provided beside the elevator car 5. A power unit 6 is installed on the elevator-car connecting member 4 (or on the elevator car 5) for rotating the nut 2, and the power unit 6 can be electric motor or hydraulic motor.

The lower end of the screw shaft 1 is a free end to be inserted in a revolving restriction mechanism 7 that is fixed on a structure unmovable relative to the supporting stand 3. The revolving restriction mechanism 7 is unrotatable but can move a small distance relative to the screw shaft 1. Since the torque area of the screw shaft 1 is located between the nut 2 and the supporting stand 3, if the screw shaft 1 is broken, it must be broken within torque area between the nut 2 and the supporting stand 3. At this moment, the elevator car 5 only can move along the screw shaft 1 since it is limited by elevator-car track, and the lower half portion of the screw shaft 1, the nut 2 and the elevator car 5 will move downward a small distance. However, the lower half portion of the screw shaft 1 will not rotate since it is locked by the revolving restriction mechanism 7. At this moment, the amount of relative rotation between the nut 2 and the screw shaft 1 is still under the control of the power unit 6, so that the position of the elevator car 5 is still controlled by the power unit 6. Therefore, the elevator car 5 will not fall even if the screw shaft 1 is broken.

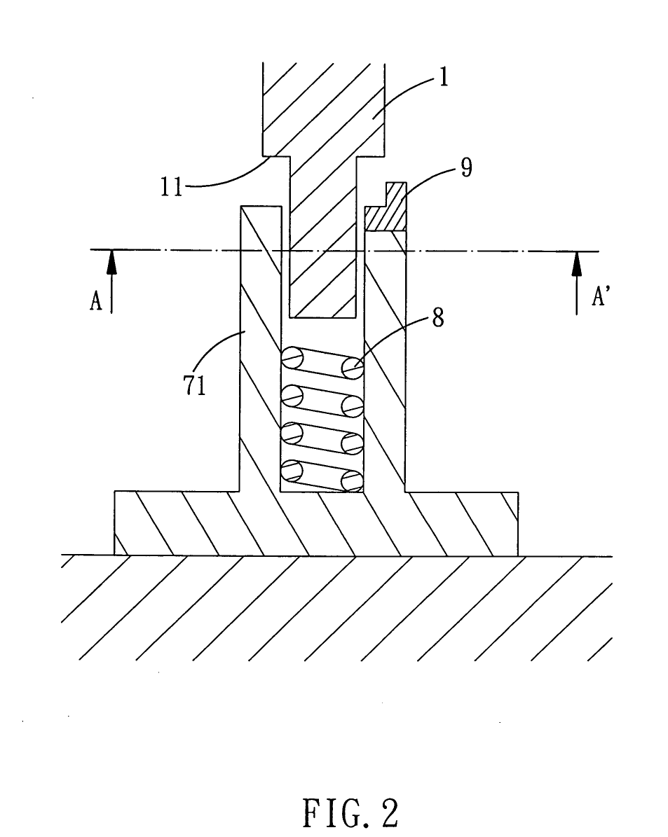

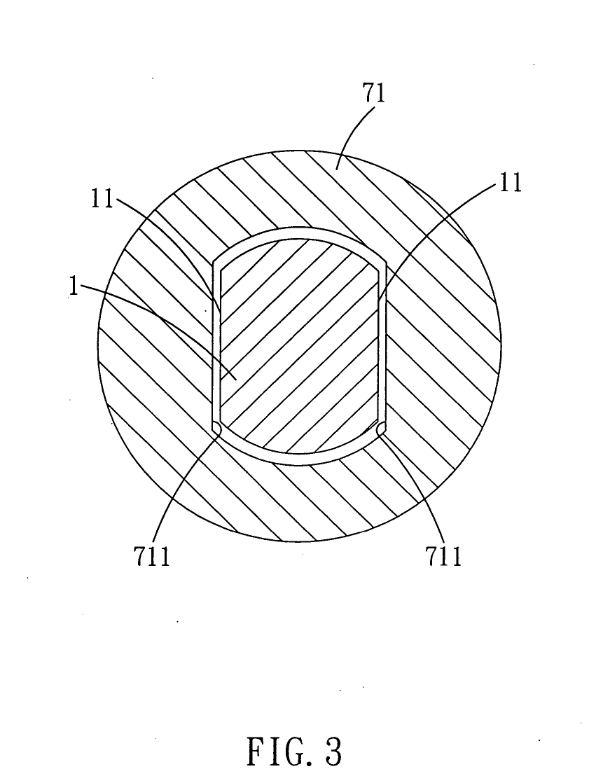

FIG. 2 is an enlarged view of the revolving restriction mechanism 7 of FIG. 1, and FIG. 3 is a cross sectional view taken along line A-A′ of FIG. 2. At both sides of the lower end of the screw shaft 1 is formed a cut surface 11. The revolving restriction mechanism 7 includes a cylindrical body 71 that has two limiting surfaces 711 for matching with the cut surfaces 11 of the screw shaft 1, so as to make the screw shaft 1 unrotatable with respect to the revolving restriction mechanism 7.

In addition, a spring 8 can be positioned in the revolving restriction mechanism 7, and the spring 8 in FIG. 2 is a compression spring located adjacent to the lower end of the screw shaft 1. When the screw shaft 1 is broken, the lower end of the screw shaft 1 will move downward along with the elevator car 5. At this moment, the spring 8 can relieve the uncomfortableness and impact caused by the rapid downward motion of the screw shaft 1. The spring 8 also can be a tension spring, only if it can adjust the relatively structure.

In the revolving restriction mechanism 7 also can be arranged a sensor 9 that is to be located above the cylindrical body 71. The sensor 9 is employed to detect potential problems of the screw shaft 1.

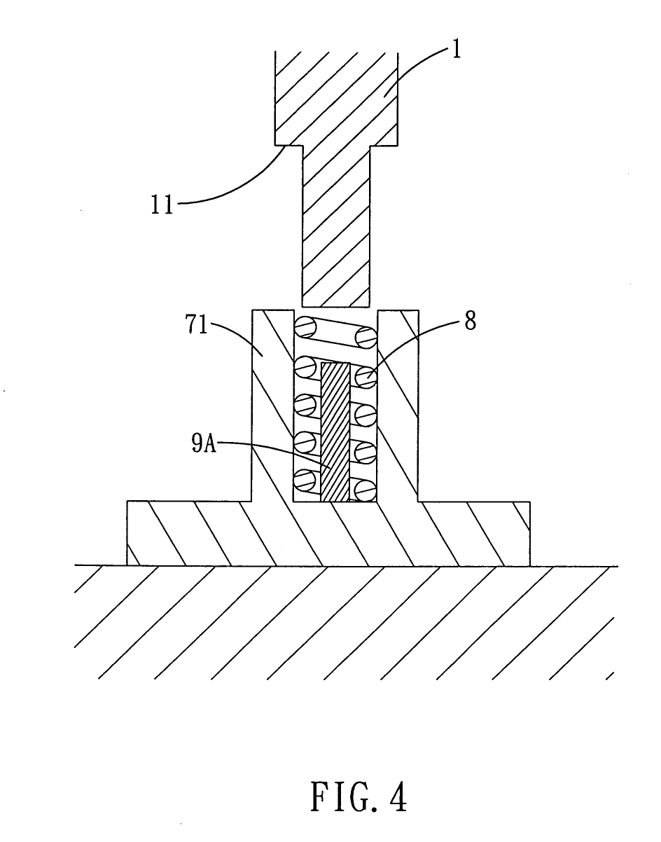

FIG. 4 shows a screw drive mechanism for an elevator in accordance with another embodiment of the present invention, in which, the lower end of the screw shaft 1 needs not to be inserted deeply into the cylindrical body 71, and it can be positioned a small distance above the cylindrical body 71. If the screw shaft 1 is broken, the lower end of screw shaft 1 will move downward to the surface of the cylindrical body 71. And the lower end of the screw shaft 1 will rotate within a small angle relative to the cylindrical body 71 before the cut surfaces 11 of the screw shaft 1 are locked into the cylindrical body 71. After a small angle rotation, the weight of the elevator car 5 will make the lower end of the screw shaft 1 insert into the cylindrical body 71, thus stopping the rotation of the lower end of the screw shaft 1. The sensor 9A in this embodiment is disposed in the revolving restriction mechanism 7, but it also can be located above the cylindrical body 71, as shown in FIG. 2.

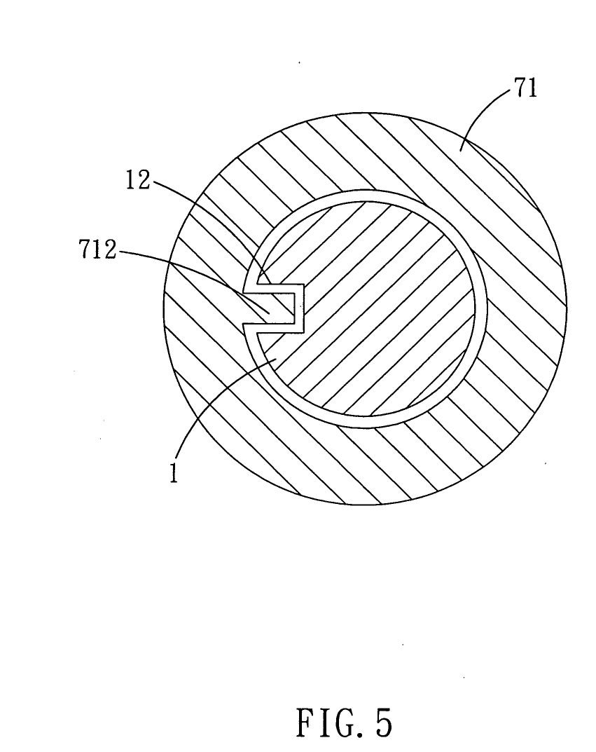

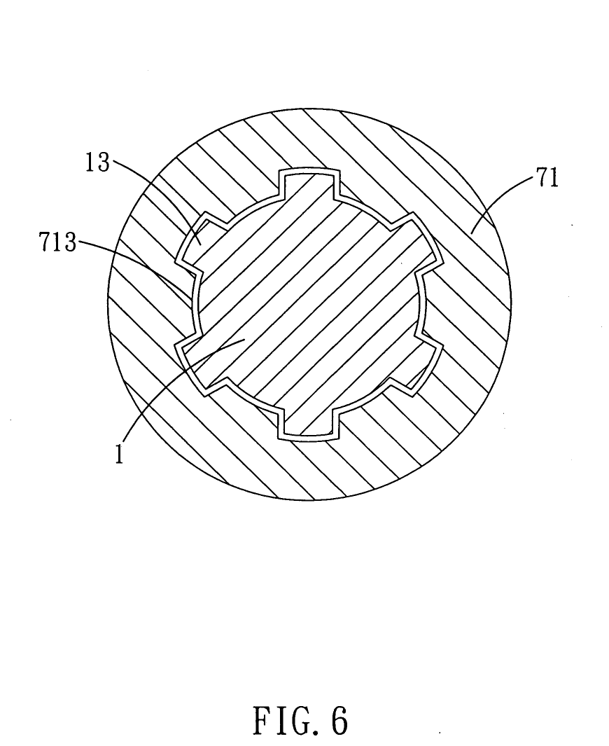

There are some other methods for limiting the relative rotation between the revolving restriction mechanism 7 and the screw shaft 1, as shown in FIGS. 5 and 6. The lower end of the screw shaft 1 of FIG. 5 is formed with a notch 12, and the cylindrical body 71 is formed with a projection 712 for matching with the notch 12, thus limiting the relative rotation between the revolving restriction mechanism 7 and the screw shaft 1. Likely, the lower end of the screw shaft 1 of FIG. 6 is formed with a square splined shaft 13, and the cylindrical body 71 is formed with a square spline 713 for mating with the square splined shaft 13, thus limiting the relative rotation between the revolving restriction mechanism 7 and the screw shaft 1.

To sum up, the present invention through analyzing the structure to reform the existing elevator is not only to provide the safety function even if the screw shaft is broken, but to have the easily installable screw drive mechanism, the sensor to check the crack for screw shaft and the spring to reduce the uncomfortableness for the elevator falling. It also has the technical innovation not only the space type but the above-mentioned function all prior to the prior art by way of analyzing.

While we have shown and described various embodiments in accordance with the present invention, it should be clear to those skilled in the art that further embodiments may be made without departing from the scope of the present invention.

What is claimed is:

1. A screw drive mechanism for an elevator comprising:
a supporting stand;
a screw shaft having an end unrotatablly fixed to the supporting stand and having an unfixed end;
a nut rotatablly screwed on the screw shaft, and a relative rotation between the nut and the screw shaft can cause a relative displacement of the nut along the screw shaft;
an elevator car connected to the nut and can move along the screw shaft along with the nut;
a power unit for rotating the nut relative to the screw shaft; and
a revolving restriction mechanism fixed on a structure unmovable relative to the supporting stand and located adjacent to the unfixed end of the screw shaft, the revolving restriction mechanism can move a small distance relative to the screw shaft and serving to limit the rotation of the unfixed end of the screw shaft when the screw shaft is broken, so that the elevator car will not fall even if the screw shaft is broken.

2. The screw drive mechanism for an elevator as claimed in claim 1, wherein the nut is a ball nut.

3. The screw drive mechanism for an elevator as claimed in claim 1, wherein a sensor is installed in the revolving restriction mechanism for detecting breach of the screw shaft.

4. The screw drive mechanism for an elevator as claimed in claim 3, wherein the sensor is located above a cylindrical body of the revolving restriction mechanism.

5. The screw drive mechanism for an elevator as claimed in claim 3, wherein the sensor is located in a cylindrical body of the revolving restriction mechanism.

6. The screw drive mechanism for an elevator as claimed in claim 1, wherein a spring is disposed in the revolving restriction mechanism for relieving uncomfortableness and impact caused by rapid downward motion of the screw shaft.

7. The screw drive mechanism for an elevator as claimed in claim 6, wherein the spring is a compression spring.

8. The screw drive mechanism for an elevator as claimed in claim 1, wherein a cut surface is formed at the unfixed end of the screw shaft, and the revolving restriction mechanism is formed with corresponding element for matching the cut surface of the unfixed end of the screw shaft.

9. The screw drive mechanism for an elevator as claimed in claim 1, wherein a notch is formed at the unfixed end of the screw shaft, and the revolving restriction mechanism is formed with corresponding element for matching the cut surface of the unfixed end of the screw shaft.

10. The screw drive mechanism for an elevator as claimed in claim 1, wherein a square splined shaft formed at the unfixed end of the screw shaft, and the revolving restriction mechanism is formed with a square spline for matching the square splined shaft of the unfixed end of the screw shaft.

11. The screw drive mechanism for an elevator as claimed in claim 1, wherein the power unit is an electric motor.

12. The screw drive mechanism for an elevator as claimed in claim 1, wherein the power unit is a hydraulic motor.

13. The screw drive mechanism for an elevator as claimed in claim 1, wherein the unfixed end of the screw shaft is inserted in the revolving restriction mechanism.

14. The screw drive mechanism for an elevator as claimed in claim 1, wherein the unfixed end of the screw shaft is located a small distance above the revolving restriction mechanism.

15. The screw drive mechanism for an elevator as claimed in claim 1, wherein the unfixed end of the screw shaft is a free end.
